(19) United States
(12) Patent Application Publication
(10) Pub. No.: US 2026/0204239 A1
(43) Pub. Date: Jul. 16, 2026

(54) UPRIGHT PIANO

(71) Applicant: KAWAI MUSICAL INSTRUMENTS MANUFACTURING CO, LTD., Hamamatsu-shi (JP)

(72) Inventor: Ryuichi SHINODA, Hamamatsu-shi (JP)

(21) Appl. No.: 19/447,304

(22) Filed: Jan. 13, 2026

(30) Foreign Application Priority Data
Jan. 16, 2025 (JP) 2025-006392

(51) Int. Cl. G10C 1/02

(52) U.S. Cl. CPC G10C 1/02

(57) ABSTRACT

An upright piano is provided. The upright piano of the present disclosure includes a right side-board and a left side-board, a front panel, a back panel, a top board, and a top-board support mechanism. The top-board support mechanism includes a rotation shaft, a support member, and a positioning portion. The support member is configured to rotate from a first contact position to a second contact position, includes a first contact portion and a second contact portion, is configured such that, in response to being located in the first contact position, the first end comes into contact with the top board located in the open position, thus supporting the top board, and is configured, in response to being located in the second contact position, to be positioned below respective upper ends of the right side-board and the left side-board.

### CROSS-REFERENCE TO RELATED APPLICATIONS

This application claims the benefit of Japanese Patent Application No. 2025-006392 filed on January 16, 2025 with the Japan Patent Office, the entire disclosure of which is incorporated herein by reference.

### BACKGROUND

The present disclosure relates to an upright piano.

Known upright pianos each include a right side-board, a left side-board, a front panel, a back panel, and a top board.

Japanese Patent No. 4635464 (Patent Document 1) discloses an upright piano including a rotating support member (a lid prop 16). This upright piano is configured such that the rotating support member is changed in its rotational position to support a top board (more specifically, an open/close board 12b), thus allowing the top board to be shifted from a closed position to an open position.

The rotating support member is configured to be rotatable counterclockwise from a top-board closed position (as shown in FIG. 1 of Patent Document 1) to a position in contact with an upper end of an upper front portion 11a (as shown in FIG. 3 of Patent Document 1). By bringing the rotating support member into contact with the upper end of the upper front portion 11a in this manner, the rotational position of the rotating support member can be fixed, and the top board can be supported stably.

### SUMMARY

In the above-described upright piano, however, in order to rotate the rotating support member from the top-board closed position to the position in contact with the upper end of the upper front portion 11a, the rotating support member needs to be rotated by 180 degrees or more, and thus, the rotation operation is cumbersome due to such a large rotation angle.

In addition, when rotating the rotating support member from the position in contact with the upper end of the upper front portion 11a to the top-board closed position in order to shift the top board from the open position to the closed position as well, the rotating support member needs to be rotated by 180 degrees or more, and thus, the rotation operation is cumbersome.

Although it may be possible to support the top board by rotating the rotating support member in a range smaller than 180 degrees, in such a case, the rotational position of the rotating support member is not fixed, thus supporting the top board in an unstable state.

Accordingly, it is desirable that one aspect of the present disclosure provide an upright piano capable of reducing the cumbersomeness of an operation in switching a top board thereof between a closed position and an open position.

An upright piano according to one aspect of the present disclosure comprises a right side-board and a left side-board, a front panel, a back panel, a top board, and a top-board support mechanism.

The front panel is provided in an area, on a side near a player, between the right side-board and the left side-board. The back panel is provided in an area, on a side far from the player, between the right side-board and the left side-board.

The top board is located over the right side-board, the left side-board, the front panel, and the back panel. The top board is configured to be shifted between a closed position and an open position. The closed position is a position in which a top of an internal space formed by the right side-board, the left side-board, the front panel, and the back panel is closed. The open position is a position in which the top of the internal space is opened.

The top-board support mechanism is configured to support the top board located in the open position.

The top-board support mechanism comprises a rotation shaft, a support member, and a positioning portion.

The rotation shaft is fixed to the right side-board or to the left side-board.

The support member has an elongated shape and includes a first end and a second end. The support member comprises a shaft insertion hole arranged closer to the second end than to the first end. The support member is pivotally supported to be rotatable by the rotation shaft inserted through the shaft insertion hole.

The positioning portion is fixed to the right side-board or to the left side-board within a rotation range of the support member. The positioning portion is configured to restrict the rotation range of the support member by being in contact with the support member.

The support member is configured to rotate from a first contact position to a second contact position.

The support member comprises a first contact portion and a second contact portion. The first contact portion is in contact with the positioning portion when the support member is located in the first contact position. The second contact portion is in contact with the positioning portion when the support member is located in the second contact position.

The support member is configured such that, in response to being located in the first contact position, the first end comes into contact with the top board located in the open position, thus supporting the top board. The support member is configured, in response to being located in the second contact position, to be positioned below respective upper ends of the right side-board and the left side-board.

In the thus-configured upright piano, the rotation range of the support member is restricted in a range from the first contact position to the second contact position.

With this configuration, when shifting the top board from the closed position to the open position, the support member is rotated to the first contact position, thus allowing the support member to be easily set at a position in which it can support the top board.

Conversely, when shifting the top board from the open position to the closed position, the support member is rotated to the second contact position, thus allowing the support member to be easily set at a position in which the entirety of the support member is housed in the internal space.

Accordingly, the upright piano of the present disclosure makes it possible to reduce cumbersomeness of an operation in switching the top board between the closed position and the open position.

The top-board support mechanism may comprise a cylindrical spacer. The cylindrical spacer may have a cylindrical shape. The cylindrical spacer may be sized to have an inner diameter of the cylinder that allows the rotation shaft to be inserted therethrough. The shaft insertion hole of the support member may be sized to have an inner diameter that allows the cylindrical spacer to be inserted therethrough. The support member may be pivotally supported to be rotatable by the rotation shaft and the cylindrical spacer, which are inserted through the shaft insertion hole.

In the above-described upright piano, in a free state where no external force is applied to the support member, the support member may be pivotally supported in a state where the first end thereof is movable, due to gravity, to a location lower than the respective upper ends of the right side-board and the left side-board.

With this configuration, when shifting the top board from the open position to the closed position, a user lifts the top board to space it apart from the support member, and the support member is thereby rotated due to gravity to come to rest at a position in which the second contact portion is in contact with the positioning portion.

In the above-described upright piano, the support member may have an elongated shape extending from the first end to the second end. The first contact portion may be configured to come into contact with a part, of the positioning portion, facing the top board.

In the thus-configured support member, such contact of the first contact portion with the positioning portion makes it possible to receive an external force, which is received by the first end from the top board, not only by the rotation shaft but also by the positioning portion. This enables the support member to support the top board more stably.

In the above-described upright piano, the support member may be configured such that the first end rotates within a movement range located rearward of the rotation shaft.

With this configuration, when shifting the top board from the open position to the closed position, a user only has to lift the top board, and the support member is thereby rotated due to gravity without the user touching the support member, until the second contact portion comes into contact with the positioning portion.

In the above-described upright piano, the support member may be configured such that a rotation range thereof from the first contact position to the second contact position is less than 90 degrees.

This makes it possible to inhibit a movement distance (i.e., rotation distance) of the support member from the first contact position to the second contact position from being too long. This in turn makes it possible to inhibit too much burden of operating the support member when shifting the top board from the closed position to the open position.

In the above-described upright piano, the top board may be configured with a single board.

Alternatively, in the above-described upright piano, the top board may be configured with two boards.

In the above-described upright piano, the top board may comprise, in a bottom surface thereof, a contact member. The contact member may include a recess sized to allow the first end of the support member to be accommodated therein. In the top board with such a contact member, contact of the first end with the recess makes it possible to inhibit misalignment in the relative position between the support member and the top board. Thus, a state in which the top board is supported by the support member can be stabilized.

### BRIEF DESCRIPTION OF THE DRAWINGS

Example embodiments of the present disclosure will be described hereinafter with reference to the accompanying drawings, in which:

FIG. 1 is a perspective view showing an external appearance of an upright piano according to the first embodiment, with a top board thereof in a closed position;

FIG. 2 is a perspective view showing an external appearance of the upright piano according to the first embodiment, with the top board thereof in an open position;

FIG. 3 is an exploded perspective view showing a support member, the top board, and so on of the upright piano;

FIG. 4 is a partial sectional view of the upright piano showing a state of the support member when the top board is in the closed position;

FIG. 5 is a partial sectional view of the upright piano showing a state of the support member when the top board is in the open position;

FIG. 6 is an explanatory view showing the back side of the support member;

FIG. 7 is a perspective view of the support member showing a section thereof taken along a line VII-VII in FIG. 6; and

FIG. 8 is a perspective view showing an external appearance of an upright piano according to the second embodiment, with a top board thereof in the open position.

### DETAILED DESCRIPTION OF EXEMPLARY EMBODIMENTS

The present disclosure is not limited to the embodiments described below and may take various forms as long as they fall within the technical scope of the present disclosure.

### 1. First Embodiment

### 1-1. Overall Configuration

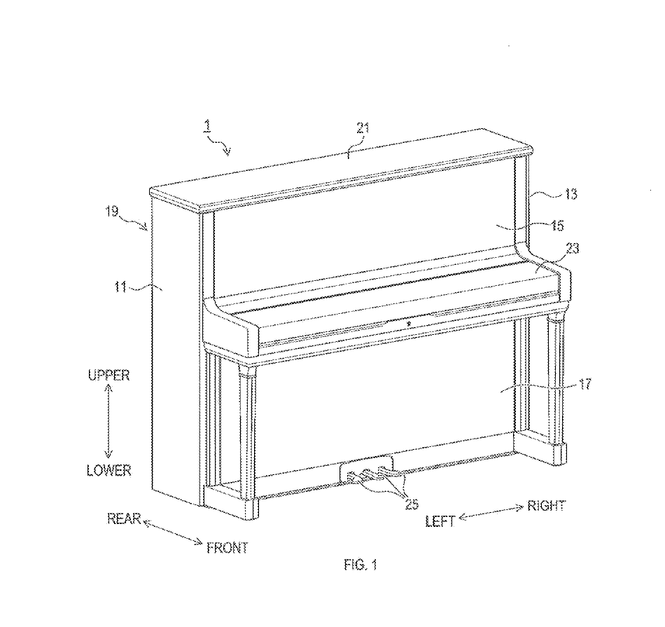

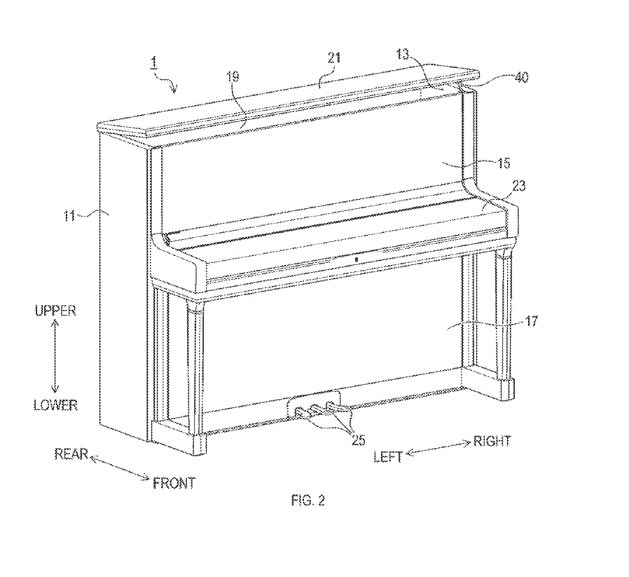

As shown in FIGS. 1 and 2, an upright piano 1 (hereinafter also simply referred to as a piano 1) comprises a left side-board 11, a right side-board 13, an upper front panel 15, a lower front panel 17, a back panel 19, a top board 21, a fallboard 23, pedals 25, and a top-board support mechanism 40.

In the description below, the near side of the piano 1 as viewed by a player (see FIG. 1) is referred to as “front”, the far side as “rear”, the upper side as “upper”, the lower side as “lower”, the left side as “left”, and the right side as “right”.

The left side-board 11 is a board member located on the left side of the piano 1. The right side-board 13 is a board member located on the right side of the piano 1. The upper front panel 15 is a plate member located on the upper front side of the piano 1. The lower front panel 17 is a plate member located on the lower front side of the piano 1. The back panel 19 is a plate member located on the rear side of the piano 1.

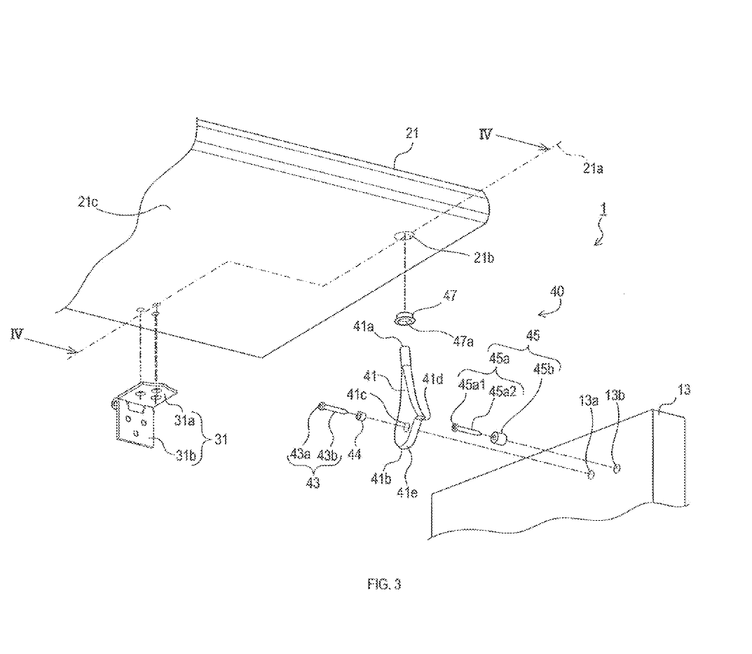

The top board 21 is a board member located over the left side-board 11, the right side-board 13, the upper front panel 15, and the back panel 19. As shown in FIGS. 3 through 5, the top board 21 is coupled to the back panel 19 via at least one hinge 31. The top board 21 is provided so as to be openable and closable by means of the at least one hinge 31. The top board 21 is configured to be movable between a closed position and an open position through a rotational movement of the at least one hinge 31.

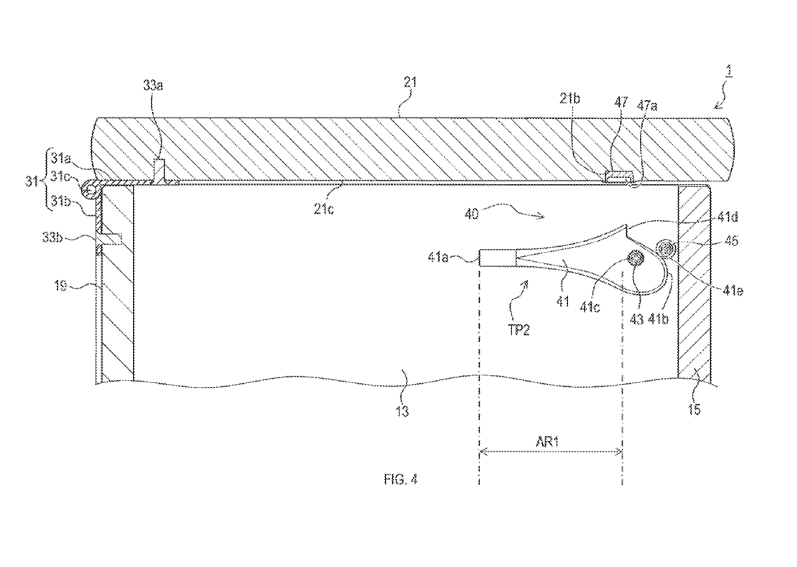

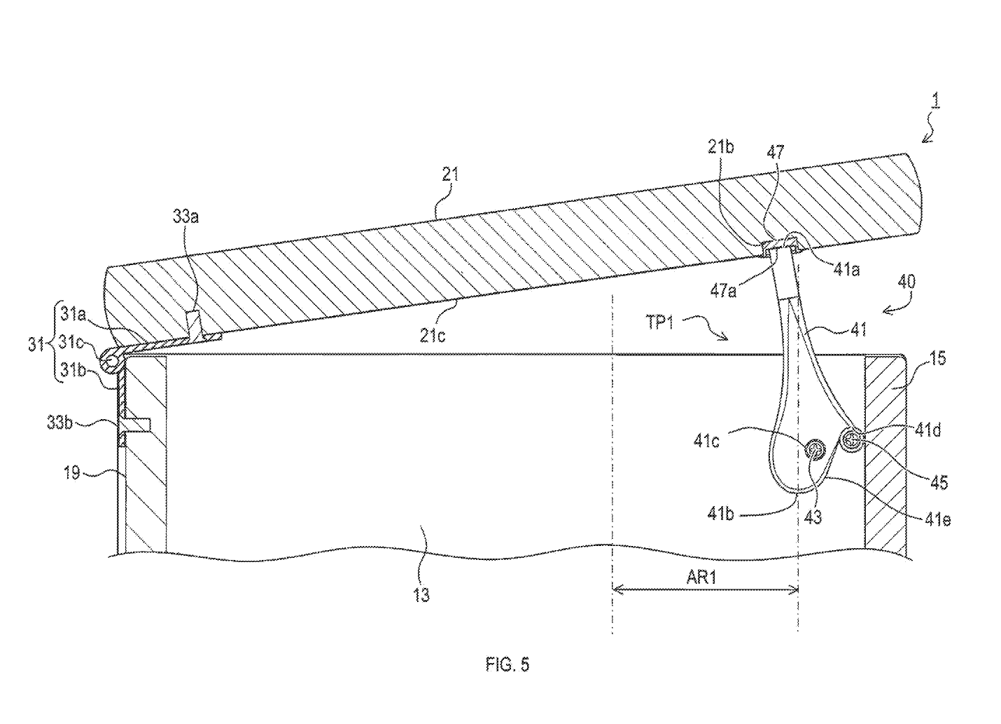

FIGS. 4 and 5 are sectional views taken along line IV-IV in FIG. 3.

As shown in FIGS. 3 through 5, the at least one hinge 31 comprises a first leaf 31a, a second leaf 31b, and a pin 31c. The first leaf 31a and the second leaf 31b are coupled by the pin 31c and configured to rotate about the pin 31c as a central axis. The first leaf 31a is fixed to the top board 21 with a fixing screw 33a. The second leaf 31b is fixed to the back panel 19 with a fixing screw 33b.

This allows the top board 21 to be coupled to the back panel 19 via the at least one hinge 31, thereby being fixed so as to be rotatable relative to the back panel 19.

FIGS. 1 and 4 each show a state in which the top board 21 is located in the closed position. Such location of the top board 21 in the closed position results in closing an upper opening of a structure formed by the left side-board 11, the right side-board 13, the upper front panel 15, and the back panel 19.

FIGS. 2 and 5 each show a state in which the top board 21 is located in the open position. Such location of the top board 21 in the open position results in opening the upper opening of the structure formed by the left side-board 11, the right side-board 13, the upper front panel 15, and the back panel 19.

The fallboard 23 is a member configured to cover a keyboard (not shown). Although not illustrated, the fallboard 23 is configured to be movable between an open position in which the keyboard is exposed and a closed position in which the keyboard is covered and hidden. The fallboard 23 is rotatably coupled via at least one hinge (not shown). The fallboard 23 is configured to rotate about the at least one hinge between the open position and the closed position.

The pedals 25 are provided below the lower front panel 17. The pedals 25 are provided to extend frontward from beneath the lower front panel 17. The number of the pedals 25 of the piano 1 is three.

The top-board support mechanism 40 is configured to support the top board 21 located in the open position. The top-board support mechanism 40 is configured to be housed inside the upright piano 1 (i.e., housed in the internal space formed by the left side-board 11, the right side-board 13, the upper front panel 15, and the back panel 19) when the top board 21 is located in the closed position.

### 1-2. Top-board Support Mechanism

Next, the top-board support mechanism 40 will be described.

As shown in FIGS. 3 through 5, the top-board support mechanism 40 comprises a support member 41, a rotation shaft 43, a cylindrical spacer 44, and a positioning portion 45.

The rotation shaft 43 is an elongated member fixed to the right side-board 13. The rotation shaft 43 is configured with a male screw. The rotation shaft 43 comprises a head 43a and a shank 43b.

The right side-board 13 comprises a first fixing hole 13a for fixing the rotation shaft 43. The first fixing hole 13a is configured to be threadedly engaged with the shank 43b of the rotation shaft 43.

The cylindrical spacer 44 is a metal member of a cylindrical shape. The cylindrical spacer 44 is sized to allow the shank 43b of the rotation shaft 43 to be inserted therethrough.

As shown in FIGS. 3 through 7, the support member 41 includes a first end 41a and a second end 41b. The support member 41 has an elongated shape extending from the first end 41a to the second end 41b. The support member 41 comprises a shaft insertion hole 41c. The shaft insertion hole 41c is arranged at a location closer to the second end 41b than to the first end 41a in the support member 41. The shaft insertion hole 41c is formed as a through-hole passing through the support member 41. The shaft insertion hole 41c is sized to have an inner diameter that allows the cylindrical spacer 44 to be inserted therethrough. That is, the support member 41 is pivotally supported to be rotatable by the rotation shaft 43 and the cylindrical spacer 44, which are inserted through the shaft insertion hole 41c.

More specifically, the cylindrical spacer 44 is fixed in a state where it is held between the head 43a of the rotation shaft 43 and the right side-board 13. An inner surface of the shaft insertion hole 41c slides along an outer peripheral surface of the cylindrical spacer 44, and the support member 41 is thereby rotated.

The positioning portion 45 is fixed to the right side-board 13 within a rotation range of the support member 41.

The positioning portion 45 comprises a shaft 45a and a buffer portion 45b.

The shaft 45a is an elongated member. The shaft 45a is configured with a male screw. The shaft 45a comprises a head 45a1 and a shank 45a2.

The buffer portion 45b is a cylindrical member formed of an elastic material (e.g., rubber, resin, or the like). The buffer portion 45b is sized to have an inner diameter that allows the shank 45a2 of the shaft 45a to be inserted therethrough. Specifically, the inner diameter of the buffer portion 45b is the same as or larger than an outer diameter of the shank 45a2. The buffer portion 45b is provided to reduce the impact that occurs between the support member 41 and the shaft 45a when the support member 41 is supported by the shaft 45a.

The right side-board 13 comprises a second fixing hole 13b for fixing the positioning portion 45 (more specifically, the shaft 45a). The second fixing hole 13b is configured to be threadedly engaged with the shank 45a2 of the shaft 45a.

The positioning portion 45 is configured to restrict the rotation range of the support member 41 by being in contact with the support member 41. More specifically, the positioning portion 45 restricts the rotation range of the support member 41 to a range from a rotational position shown in FIG. 4 (hereinafter referred to as a second contact position TP2) to a rotational position shown in FIG. 5 (hereinafter referred to as a first contact position TP1).

The support member 41 is configured to rotate from the first contact position TP1 shown in FIG. 5 to the second contact position TP2 shown in FIG. 4.

As seen from FIGS. 4 and 5, the support member 41 is configured such that the rotation range thereof from the first contact position TP1 to the second contact position TP2 is less than 90 degrees.

The support member 41 comprises a first contact portion 41d and a second contact portion 41e. The first contact portion 41d and the second contact portion 41e are portions each coming into contact with the positioning portion 45. The first contact portion 41d is in contact with the positioning portion 45 when the support member 41 is located in the first contact position TP1. The second contact portion 41e is in contact with the positioning portion 45 when the support member 41 is located in the second contact position TP2.

As shown in FIGS. 3 through 5, the top board 21 comprises a contact member 47. The contact member 47 is formed in a cylindrical shape with a bottom. The contact member 47 comprises a recess 47a. The recess 47a is sized to allow the first end 41a of the support member 41 to be accommodated therein.

The top board 21 comprises an embedding hole 21b where the contact member 47 is embedded. The embedding hole 21b is arranged in a bottom surface 21c of the top board 21. The bottom surface 21c is a surface, of the top board 21, facing the internal space formed by the left side-board 11, the right side-board 13, the upper front panel 15, and the back panel 19.

The contact member 47 is embedded in the embedding hole 21b in a state where the recess 47a faces the support member 41.

As shown in FIG. 5, the support member 41 is configured such that, in response to being located in the first contact position TP1, the first end 41a comes into contact with the top board 21 located in the open position, thus supporting the top board 21. More specifically, the first end 41a comes into contact with the recess 47a of the contact member 47 of the top board 21 located in the open position.

As shown in FIG. 4, the support member 41 is configured, in response to being located in the second contact position TP2, to be positioned below an upper end of the right side-board 13.

In a free state where no external force is applied to the support member 41, the support member 41 is pivotally supported in a state where the first end 41a thereof is movable, due to gravity, to a location lower than the upper end of the right side-board 13. Specifically, an inner diameter of the shaft insertion hole 41c is sized to be larger than an outer diameter of the cylindrical spacer 44. This results in reducing a frictional force between an inner wall of the shaft insertion hole 41c and the outer peripheral surface of the cylindrical spacer 44, thus allowing the first end 41a to be moved, due to gravity, to the location lower than the upper end of the right side-board 13 in the free state of the support member 41. Therefore, when shifting the top board 21 from the open position to the closed position, a user lifts the top board 21 to space it apart from the support member 41, and the support member 41 is thereby rotated due to gravity to come to rest at a position in which the second contact portion 41e is in contact with the positioning portion 45.

A mode of supporting the support member 41 by the rotation shaft 43 and the cylindrical spacer 44 is not limited to this one. For example, the inner diameter of the shaft insertion hole 41c and the outer diameter of the cylindrical spacer 44 may be adjusted so that a light frictional force, which inhibits the support member 41 from moving due to gravity, is generated between the inner wall of the shaft insertion hole 41c and the outer peripheral surface of the cylindrical spacer 44. In this case, the rotational position of the support member 41 may be changed by the user’s operation of the support member 41.

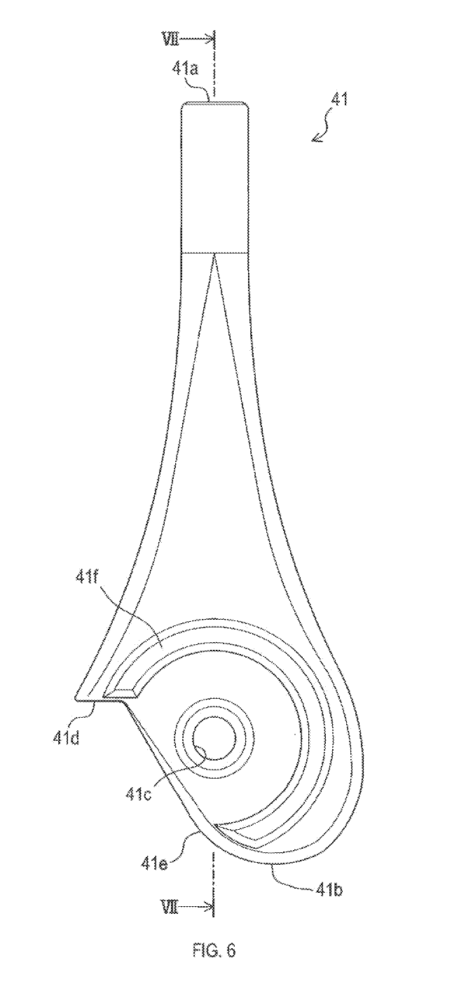

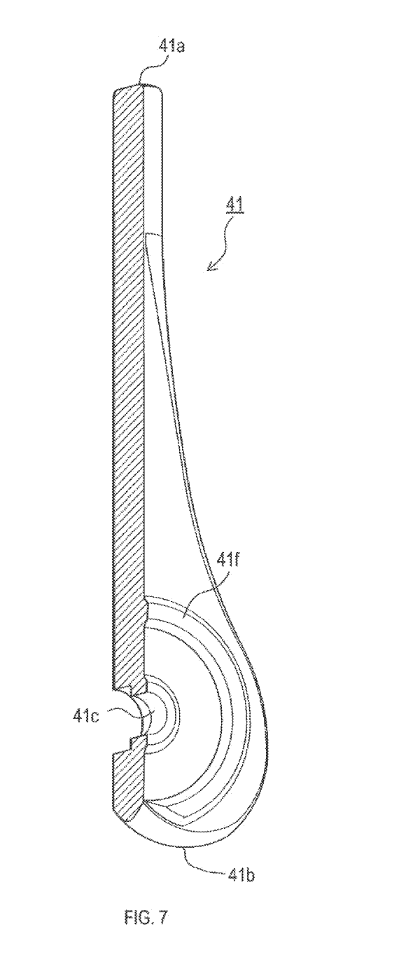

As shown in FIGS. 6 and 7, the support member 41 comprises a ridge portion 41f on the side opposite that shown in FIGS. 4 and 5. The ridge portion 41f is formed on the surface of the support member 41 in a protruding manner. The ridge portion 41f is formed as a portion of a circle centered on the shaft insertion hole 41c. That is, the ridge portion 41f is formed in an arc shape as a portion of the circle centered on the shaft insertion hole 41c, not as an entire circumference of the circle. Provision of the ridge portion 41f allows the support member 41 to have a reduced area of contact with the right side-board 13, thus inhibiting a frictional force generated between the support member 41 and the right side-board 13 from being too large.

The first contact portion 41d is configured to come into contact with a part, of the positioning portion 45, facing the top board 21.

In the thus-configured support member 41, such contact of the first contact portion 41d with the positioning portion 45 makes it possible to receive an external force, which is received by the first end 41a from the top board 21, not only by the rotation shaft 43 but also by the positioning portion 45. That is, the support member 41 is configured to support the top board 21 in a state where the support member 41 is supported at two locations, that is, by the rotation shaft 43 and the positioning portion 45. This enables the support member 41 to support an object with a heavier weight than in a mode in which it is supported at a single location (e.g., by the rotation shaft 43) alone, and thus, the top board 21 can be supported more stably.

As shown in FIGS. 4 and 5, the support member 41 is configured such that the first end 41a rotates within a movement range AR1 located rearward (i.e., on the back side) of the rotation shaft 43.

With this configuration, in response to moving the top board 21 in the state shown in FIG. 5 upward, the support member 41 rotates naturally due to gravity without the necessity of external force applied thereto, and moves until the second contact portion 41e comes into contact with the positioning portion 45.

Accordingly, when moving the top board 21 from the open position to the closed position, a user only has to simply move the top board 21 upward (i.e., lift the top board 21), and the support member 41 moves from the first contact position TP1 (see FIG. 5) to the second contact position TP2 (see FIG. 4) without the user touching the support member 41. Then, the user can move the top board 21 from the open position to the closed position by lowering the top board 21 to the closed position.

This allows the user to move the top board 21 from the open position to the closed position with only one hand, thus reducing a workload on the user.

The support member 41 has a decorative finish on its surface. Specifically, the support member 41 is plated in a gold color. With such a decoration on the support member 41, it can produce a sense of luxury and improve the overall aesthetics of the upright piano 1.

### 1-3. Effects

The embodiment detailed above can achieve the following effects:

In the upright piano 1, when shifting the top board 21 from the closed position to the open position, the support member 41 is rotated to the first contact position TP1, thus allowing the support member 41 to be easily set at a position in which it can support the top board 21.

Conversely, when shifting the top board 21 from the open position to the closed position, the support member 41 is rotated to the second contact position TP2, thus allowing the support member 41 to be easily set at a position in which the entirety of the support member 41 is housed in the internal space.

Accordingly, the upright piano 1 makes it possible to reduce the cumbersomeness of the operation in switching the top board 21 between the closed position and the open position.

In the upright piano 1, when shifting the top board 21 from the open position to the closed position, a user lifts the top board 21 to space it apart from the support member 41, and the support member 41 is thereby rotated due to gravity without the user touching the support member 41. Then, the second contact portion 41e comes into contact with the positioning portion 45, thereby causing the support member 41 to rest in the second contact position TP2.

In the upright piano 1, the support member 41 is configured to support the top board 21 in the state where the support member 41 is supported at two locations, that is, by the rotation shaft 43 and the positioning portion 45. This enables the support member 41 to support an object with a heavier weight than in a mode in which it is supported at a single location (e.g., by the rotation shaft 43) alone, and thus, the top board 21 can be supported more stably.

In the upright piano 1, the support member 41 is configured such that the rotation range thereof from the first contact position TP1 to the second contact position TP2 is less than 90 degrees. This makes it possible to inhibit a movement distance (i.e., rotation distance) of the support member 41 from the first contact position TP1 to the second contact position TP2 from being too long. This in turn makes it possible to inhibit too much burden of operating the support member 41 when shifting the top board 21 from the closed position to the open position.

In the upright piano 1, the top board 21 comprises the contact member 47, and the first end 41a comes into contact with the recess 47a of the contact member 47. This makes it possible to inhibit misalignment in the relative position between the support member 41 and the top board 21, thus stabilizing a state in which the top board 21 is supported by the support member 41.

### 1-4. Correspondence between Terms

The upper front panel 15 and the lower front panel 17 each correspond to one example of the front panel of the present disclosure.

Although the first embodiment of the present disclosure has been described so far, the present disclosure is not limited to the above-described first embodiment and may take various forms as long as they fall within the technical scope of the present disclosure.

### 2. Second Embodiment

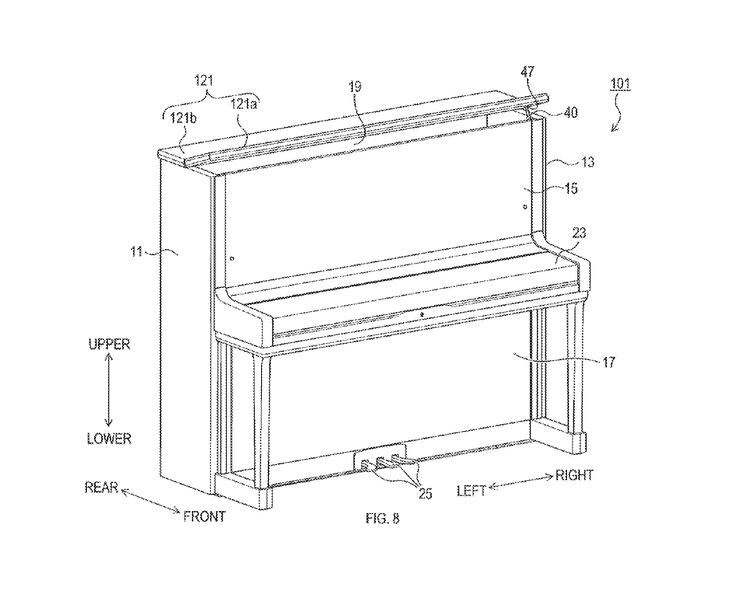

(2A) In the above-described first embodiment, the top board 21 is configured with a single board. However, the configuration of the upright piano of the present disclosure is not limited thereto. For example, as shown in FIG. 8, the top board may comprise two boards.

A second upright piano 101 shown in FIG. 8 is configured by replacing the top board 21 of the upright piano 1 of the first embodiment with a second top board 121.

The second top board 121 comprises a movable board 121a and a fixed board 121b. The movable board 121a is located on the front side of a top of the internal space formed by the left side-board 11, the right side-board 13, the upper front panel 15, and the back panel 19. The fixed board 121b is located on the rear side of the top of this internal space.

The fixed board 121b is fixed onto the left side-board 11, the right side-board 13, and the back panel 19. The movable board 121a is coupled to the fixed board 121b via at least one hinge (not shown). The movable board 121a is provided so as to be openable and closable by means of the at least one hinge. The movable board 121a is configured to be movable between a closed position and an open position through a rotational movement of the at least one hinge.

The second upright piano 101 comprises the top-board support mechanism 40 similar to that of the first embodiment. As shown in FIG. 8, the second upright piano 101 is configured such that the movable board 121a of the second top board 121 can be maintained at the open position by the top-board support mechanism 40.

Although not illustrated, the movable board 121a of the second top board 121 is configured to be rotated by means of the at least one hinge to thereby be shifted to the closed position in which the movable board 121a closes the top of the internal space formed by the left side-board 11, the right side-board 13, the upper front panel 15, and the back panel 19.

In this manner, in the second upright piano 101 provided with the second top board 121 including the two boards (i.e., the movable board 121a and the fixed board 121b) as well, provision of the top-board support mechanism 40 makes it possible to achieve the effects similar to those of the upright piano 1 of the first embodiment.

### 3. Other Embodiments

(3A) In the above-described first and second embodiments, the top-board support mechanism 40 is provided to the right side-board 13. However, the configuration of the upright piano of the present disclosure is not limited thereto. For example, the top-board support mechanism 40 may be provided to the left side-board 11.

(3B) In the above-described first and second embodiments, the support member is decorated with the plating in a gold color. However, the decoration of the support member in the upright piano of the present disclosure is not limited thereto. For example, the support member may be decorated with a plating in a silver color or may be decorated with a plating in a combination of gold and silver colors.

(3C) In the above-described first and second embodiments, the top board 21 comprises the contact member 47. However, the configuration of the upright piano of the present disclosure is not limited thereto. For example, a configuration may be employed in which the top board does not comprise the contact member 47 and in which the first end 41a of the support member 41 comes into contact with the embedding hole 21b.

(3D) In the above-described first and second embodiments, the cylindrical spacer 44 is provided. However, the configuration of the upright piano of the present disclosure is not limited thereto. For example, a configuration may be employed in which the cylindrical spacer is not provided and in which the rotation shaft 43 alone is inserted through the shaft insertion hole 41c of the support member 41. In this case, the shaft insertion hole 41c may be sized to have an inner diameter that allows the rotation shaft 43 to be inserted therethrough. That is, the support member 41 may be pivotally supported to be rotatable by the rotation shaft 43 inserted through the shaft insertion hole 41c. Moreover, the rotation shaft 43 may be threadedly engaged with the first fixing hole 13a in the right side-board 13 in a state where the distance between the head 43a and the right side-board 13 is larger than the thickness of the support member 41. With this configuration, when shifting the top board 21 from the open position to the closed position, a user lifts the top board 21 to space it apart from the support member 41, and the support member 41 is thereby rotated due to gravity to come to rest at a position in which the second contact portion 41e is in contact with the positioning portion 45.

The mode of supporting the support member 41 by the rotation shaft 43 alone is not limited thereto. For example, the threaded engagement of the rotation shaft 43 with the first fixing hole 13a may be adjusted so as to achieve a state in which the support member 41 is clamped between the head 43a and the right side-board 13 with a light force. In other words, the threaded engagement of the rotation shaft 43 with the first fixing hole 13a may be adjusted so as to achieve a state in which a light frictional force is generated between the head 43a and the support member 41, and between the right side-board 13 and the support member 41. In this case, the rotational position of the support member 41 may be changed by the user’s operation of the support member 41.

(3E) Two or more functions achieved by a single element in the above-described first and second embodiments may be achieved by two or more elements, and a single function achieved by a single element may be achieved by two or more elements. Two or more functions achieved by two or more elements may be achieved by a single element, and a single function achieved by two or more elements may be achieved by a single element. A portion of the configurations in the above-described embodiments may be omitted. At least a portion of the configuration in one of the above-described embodiments may be added to or replace the configuration in another one of the above-described embodiments.

What is claimed is:

1. An upright piano comprising:
a right side-board and a left side-board;
a front panel provided in an area, on a side near a player, between the right side-board and the left side-board;
a back panel provided in an area, on a side far from the player, between the right side-board and the left side-board;
a top board located over the right side-board, the left side-board, the front panel, and the back panel and configured to be shifted between a closed position and an open position, the closed position being a position in which a top of an internal space formed by the right side-board, the left side-board, the front panel, and the back panel is closed, the open position being a position in which the top of the internal space is opened; and
a top-board support mechanism configured to support the top board located in the open position;
the top-board support mechanism including:
a rotation shaft fixed to the right side-board or to the left side-board;
a support member having an elongated shape and including a first end and a second end, the support member including a shaft insertion hole arranged closer to the second end than to the first end, the support member being pivotally supported to be rotatable by the rotation shaft inserted through the shaft insertion hole; and
a positioning portion fixed to the right side-board or to the left side-board within a rotation range of the support member and configured to restrict the rotation range of the support member by being in contact with the support member,
the support member being configured to rotate from a first contact position to a second contact position,
the support member including:
a first contact portion being in contact with the positioning portion when the support member is located in the first contact position; and
a second contact portion being in contact with the positioning portion when the support member is located in the second contact position,
the support member being configured such that, in response to being located in the first contact position, the first end comes into contact with the top board located in the open position, thus supporting the top board, and
the support member being configured, in response to being located in the second contact position, to be positioned below respective upper ends of the right side-board and the left side-board.

2. The upright piano according to claim 1,
wherein, in a free state where no external force is applied to the support member, the support member is pivotally supported in a state where the first end thereof is movable, due to gravity, to a location lower than the respective upper ends of the right side-board and the left side-board.

3. The upright piano according to claim 2,
wherein the support member has an elongated shape extending from the first end to the second end, and
wherein the first contact portion is configured to come into contact with a part of the positioning portion, facing the top board.

4. The upright piano according to claim 3,
wherein the support member is configured such that the first end rotates within a movement range located rearward of the rotation shaft.

5. The upright piano according to claim 4,
wherein the support member is configured such that a rotation range thereof from the first contact position to the second contact position is less than 90 degrees.

6. The upright piano according to claim 5,
wherein the top board is configured with a single board.

7. The upright piano according to claim 5,
wherein the top board is configured with two boards.

8. The upright piano according to claim 1,
wherein the top board includes, in a bottom surface thereof, a contact member with a recess sized to allow the first end of the support member to be accommodated therein.

9. The upright piano according to claim 2,
wherein the top board includes, in a bottom surface thereof, a contact member with a recess sized to allow the first end of the support member to be accommodated therein.

10. The upright piano according to claim 3,
wherein the top board includes, in a bottom surface thereof, a contact member with a recess sized to allow the first end of the support member to be accommodated therein.

11. The upright piano according to claim 4,
wherein the top board includes, in a bottom surface thereof, a contact member with a recess sized to allow the first end of the support member to be accommodated therein.

12. The upright piano according to claim 5,
wherein the top board includes, in a bottom surface thereof, a contact member with a recess sized to allow the first end of the support member to be accommodated therein.

13. The upright piano according to claim 6,
wherein the top board includes, in a bottom surface thereof, a contact member with a recess sized to allow the first end of the support member to be accommodated therein.

14. The upright piano according to claim 7,
wherein the top board includes, in a bottom surface thereof, a contact member with a recess sized to allow the first end of the support member to be accommodated therein.
